(19) United States
(12) Patent Application Publication
(10) Pub. No.: US 2008/0106986 A1
(43) Pub. Date: May 8, 2008

(54) INFORMATION RECORDING MEDIUM, AND RECORDING/REPRODUCING METHOD AND APPARATUS THEREFOR

(75) Inventors: WOOK-YEON HWANG, Seoul (KR); Kyung-geun Lee, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/935,025

(22) Filed: Nov. 5, 2007

(30) Foreign Application Priority Data
Nov. 6, 2006 (KR) 2006-108838

(51) Int. Cl. G11B 7/24; G11B 5/09

(52) U.S. Cl. 369/47.27; 369/275.3

(57) ABSTRACT

Provided are an information recording medium, and an information recording/reproducing method and apparatus, which are capable of allowing an equalizer (EQ) value to be automatically set or to be rapidly set by the recording/reproducing apparatus. The information recording medium has recorded thereon EQ gain information appropriate or specific to the information recording medium for optimized reproduction of data from the information recording medium.

### CROSS-REFERENCE TO RELATED APPLICATION

This application claims all benefits accruing under 35 U.S.C. §119 from Korean Patent Application No. 2006-108838, filed on Nov. 6, 2006 in the Korean Intellectual Property Office, the disclosure of which is incorporated herein by reference.

### BACKGROUND OF THE INVENTION

1. Field of the Invention

The present invention relates to an information recording medium, and an information recording/reproducing method and apparatus, which are capable of allowing an equalizer (EQ) value appropriate or specific for the information recording medium to be automatically set or to be rapidly set by the recording/reproducing apparatus.

2. Description of the Related Art

In general, an optical storage medium, such as an optical disc, has been extensively employed as a storage medium for an optical pickup device that records or reproduces information in a non-contact manner. The optical storage medium is classified into a compact disc (CD) and a digital versatile disc (DVD) according to storage capacity. Accordingly, the optical storage medium includes optical discs, such as a 650 MB CD-R (CD-Recordable), a CD-RW (CD-Rewritable), a 4.7 GB DVD+R/RW, a DVD-RAM (Random Access Memory), and a DVD-R/RW, on which recording, erasing and/or reproducing are allowed. The optical storage medium also includes read-only discs, such as a 650 MB CD and a 4.7 GB DVD-ROM. Furthermore, a high-definition (HD) DVD or a BD (Blu-Ray Disc) having storage capacity of 15 GB or greater has been developed, and research has been conducted into development of discs whose storage capacity is greater than 15 GB, e.g., a Super-RENS (Resolution Near Field Structure) disc employing a super-resolution reproduction technique.

In the case of media that have already been placed or are to be placed on the market, an EQ (equalizer) value defined for each optical disc standard is specified so that the EQ value can be set in a recording/reproducing apparatus to perform a read operation under optimum reproduction conditions. However, only one EQ value is specified according to each type or storage capacity of a medium. Therefore, as a method of manufacturing a new type of medium is introduced in order to improve the high-density performance of an optical storage medium and to reduce the price thereof, an optimal EQ value for even the same type of medium may be different from the EQ value defined for a standard, for example, depending on how the medium is manufactured or characteristics of materials used for the medium.

FIGS. 1A-1F illustrate characteristic relative to typical once-writable information recording media. Specifically, FIG. 1A illustrates marks 2T and 5T on a first once-writable information recording medium. FIG. 1B illustrates a waveform of a signal indicating detection of the marks 2T and 5T illustrated in FIG. 1A. FIG. 1C illustrates a waveform of a binary signal obtained by slicing (or cutting-off) the waveform of the signal illustrated in FIG. 1B.

As illustrated in FIGS. 1A-1C, if the size of the small mark 2T is appropriate, an EQ value becomes small but the effect caused by the inter symbol interference is increased. That is, it is possible to detect a signal indicating the marks 2T and 5T without setting a higher filter gain value of an equalizer.

FIG. 1D illustrates marks 2T and 5T on a second once-writable information recording medium. FIG. 1E illustrates a waveform of a signal indicating detection of the marks 2T and 5T illustrated in FIG. 1D. FIG. 1F illustrates a waveform of a binary signal obtained by slicing (or cutting-off) the waveform of the signal illustrated in FIG. 1E. Although the marks 2T and 5T illustrated in FIG. 1A are respectively the same as those in FIG. 1D, their sizes would actually vary according to the type of information recording medium.

Referring to FIGS. 1D-1F, optimal reproduction characteristics can be obtained by reducing the size of the mark 2T in order to avoid interferences caused by the marks 2T and 5T, but an EQ value must be increased in this case. That is, referring to FIG. 1E, because the size of the mark 2T is small, a signal waveform for the space between the marks 2T and 5T is located below a slice (or a cut-off) level and thus, it is difficult to appropriately detect (or distinguish) the signal for the marks 2T and 5T. Therefore, a point S of the signal waveform needs to be boosted by an amount Q in order to precisely detect the signal. Here, Q represents an extent of an EQ gain of an equalizer.

As described above, optimal EQ values of even the same type of once-writable information recording media may vary depending on the actual characteristics of the once-writable information recording media.

FIGS. 2A and 2B respectively illustrate a result of measuring an EQ value and optimal jitter while changing the EQ value of a once-writable information recording medium. In detail, FIG. 2A is a graph illustrating a relationship between an EQ gain and a jitter value in the first once-writable information recording medium illustrated in FIGS. 1A-1C, and FIG. 2B is a graph illustrating a relationship between an EQ gain and a jitter value in the second once-writable information recording medium illustrated in FIGS. 1D-1F. Referring to FIG. 2A, the jitter value in the first information recording medium is smallest when the EQ value is 7 dB, and referring to FIG. 2B, the jitter value in the second information recording medium is smallest when the EQ value is 5 dB. That is, even the same type of information recording media may have different optimal EQ values for a minimum jitter value.

Accordingly, it is required to provide an EQ value appropriate or specific for each information recording medium according to characteristics thereof.

### SUMMARY OF THE INVENTION

The present invention provides an information recording medium and a recording/reproducing method and apparatus, in which equalizer (EQ) values appropriate or specific for the information recording medium are recorded in a predetermined area of the information recording medium in order to allow the EQ values to be automatically set or be rapidly set by the recording/reproducing apparatus.

Additional aspects and/or advantages of the invention will be set forth in part in the description which follows and, in part, will be obvious from the description, or may be learned by practice of the invention.

According to an example embodiment of the present invention, provided is an information recording medium having a lead-in area, a lead-out area, and a data area, and containing data to be rendered via a recording/reproducing apparatus, the medium including equalizer gain information recorded thereon, which is specific to the information recording medium, and which enables optimized reproduction of the data recorded on the information recording medium by the recording/reproducing apparatus.

According to an example embodiment of the present invention, the equalizer gain information is recorded in at least one of a lead-in area, a lead-out area, and a BCA (burst cutting area) of the information recording medium. The equalizer gain information may be a first equalizer gain or a second equalizer gain for reproduction of data from the information recording medium, where the first and second equalizer gains are expressed using one bit. The equalizer gain information may be an equalizer gain for reproduction of data from the information recording medium, where the equalizer gain is expressed with a numerical value. The equalizer gain information may be set to vary according to a record layer, a write speed, and/or material characteristics of the information recording medium. The equalizer gain information is a value having a minimum jitter value. The equalizer gain information is specific as to whether the information recording medium is a write-once disc or a rewritable disc.

According to another example aspect of the present invention, provide is an apparatus for reproducing data from and/or record data on an information recording medium, the apparatus including a pickup unit to emit and/or receive a light to transfer data with respect to the information recording medium; a controller to control the pickup unit to read equalizer gain information that is recorded on the information recording medium, which is specific to the information recording medium, and which enables optimized reproduction of data from the information recording medium; and an equalizer to equalize a signal output from the pickup unit according to the equalizer gain information.

According to another example embodiment of the present invention, provided is a method of reproducing data from an information recording medium, the method including reading equalizer gain information specific to the information recording medium, and which enables optimized reproduction of data from the information recording medium; setting an equalizer according to the equalizer gain information; and equalizing a data signal read from the information recording medium using the set equalizer and then reproducing the data signal.

According to another aspect of the present invention, provided is an apparatus for recording data on or reproducing data from an information recording medium, the apparatus including a recording/reading unit to record data on or read data from the information recording medium; an equalizer to equalize a data signal read from the information recording medium via the recording/reading unit according to equalizer gain information; and a controller to determine the equalizer gain information that is specific to the information recording medium, and which enables optimized reading of data from the information recording medium during equalizing of the read data signal by adjusting the equalizer gain, and to control the recording/reading unit to record or read the equalizer gain information on the information recording medium.

According to another aspect of the present invention, provided is a method of recording data on an information recording medium, the method including reading a data signal from the information recording medium; determining equalizer gain information specific to the information recording medium, and which enables optimized reading of the data signal from the information recording medium by adjusting the equalizer gain; and recording the equalizer gain information on the information recording medium.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIGS. 1A-1F illustrate characteristic relative to typical once-writable information recording media, where

FIG. 1A illustrates marks 2T and 5T on a first once-writable information recording medium,

FIG. 1B illustrates a waveform of a signal indicating detection of the marks 2T and 5T illustrated in FIG. 1A,

FIG. 1C illustrates a waveform of a binary signal obtained by slicing the waveform of the signal illustrated in FIG. 1B,

FIG. 1D illustrates marks 2T and 5T on a second once-writable information recording medium,

FIG. 1E illustrates a waveform of a signal indicating detection of the marks 2T and 5T illustrated in FIG. 1D, and

FIG. 1F illustrates a waveform of a binary signal obtained by slicing the waveform of the signal illustrated in FIG. 1E;

FIG. 2A is a graph illustrating a relationship between an equalizer (EQ) gain and a jitter value in the first information recording medium illustrated in FIGS. 1A-1C;

FIG. 2B is a graph illustrating a relationship between an EQ gain and a jitter value in the second information recording medium illustrated in FIG. 1D-1F;

FIG. 3A is a diagram illustrating a structure of an information recording medium according to an example embodiment of the present invention;

FIG. 3B is a diagram illustrating a structure of an information recording medium according to another example embodiment of the present invention;

FIG. 4A illustrates a format of EQ gain information illustrated in FIG. 3A or FIG. 3B, according to an example embodiment of the present invention;

FIG. 4B illustrates a format of the EQ gain information illustrated in FIG. 3A or FIG. 3B, according to another example embodiment of the present invention;

FIG. 5 is a schematic block diagram of a recording/reproducing apparatus according to an example embodiment of the present invention;

FIG. 6 is a flowchart illustrating a method of recording EQ gain information during manufacture of an information recording medium according to an example embodiment of the present invention; and

FIG. 7 is a flowchart illustrating a method of reproducing data by obtaining EQ gain information from an information recording medium according to an example embodiment of the present invention.

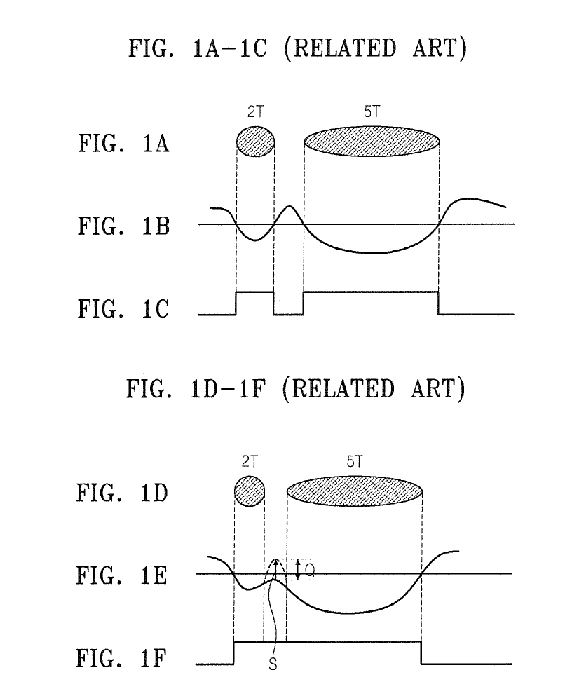

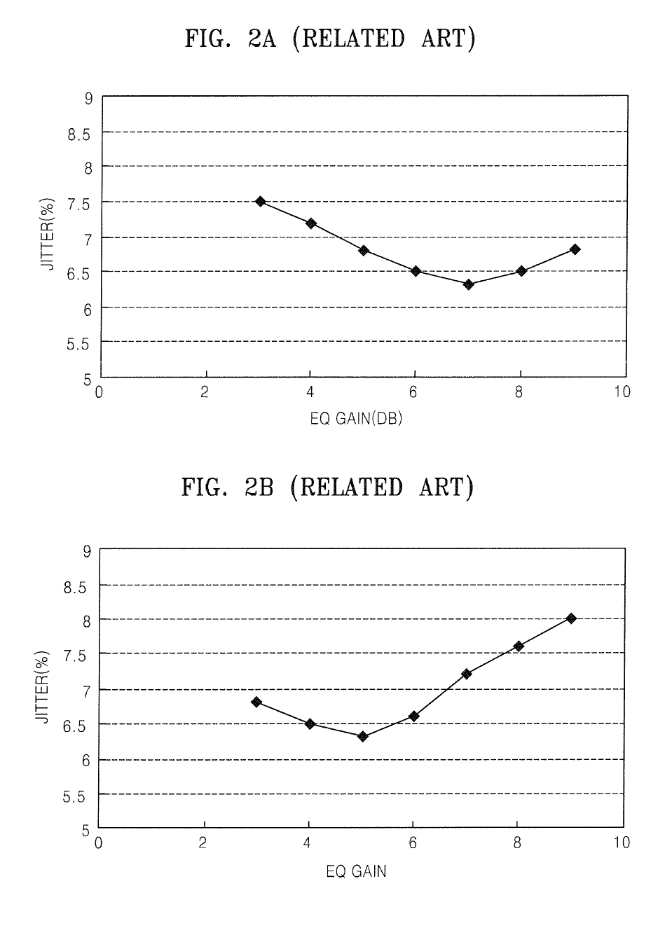

### DETAILED DESCRIPTION OF THE EMBODIMENTS

Reference will now be made in detail to the example embodiments of the present invention, examples of which are illustrated in the accompanying drawings, wherein like reference numerals refer to the like elements throughout. The example embodiments are described below in order to explain the present invention by referring to the figures.

According to example embodiments of the present invention, equalizer (EQ) gain information is recorded in a predetermined area of an information recording medium during manufacture of the information recording medium, for example, or may be recorded during use of the information recording medium after manufacture thereof. The EQ gain information may be recorded on a recordable information recording medium and/or a read-only information recording medium. Also, while data is reproduced from such an information recording medium, it is possible to perform fast equalizer adjustment on the information recording medium by obtaining the EQ gain information recorded in the predetermined area of the information recording medium.

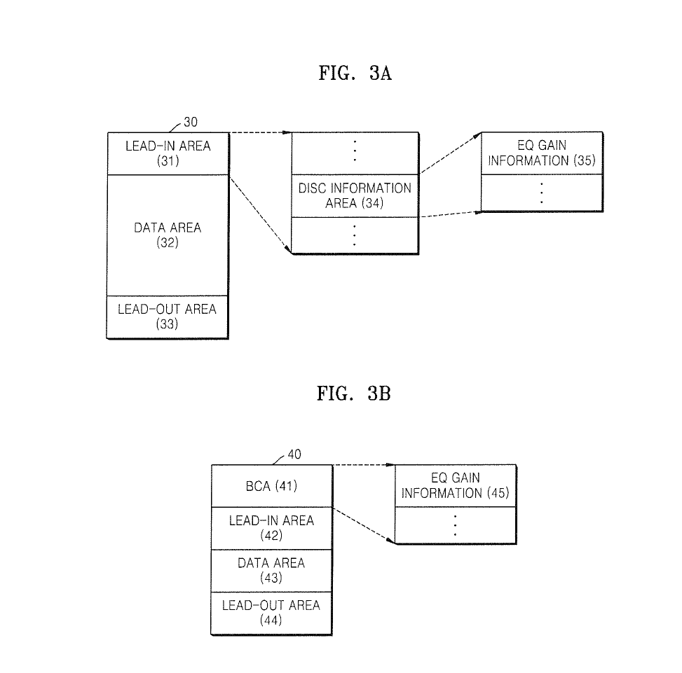

FIG. 3A is a diagram illustrating a structure of an information recording medium 30 according to an example embodiment of the present invention. Referring to FIG. 3A, the information recording medium 30 includes a lead-in area 31, a data area 32, and a lead-out area 33. The lead-in area 31 includes a disc information area 34 in which information regarding the information recording medium 30 can be recorded. EQ gain information 35 may be recorded in the disc information area 34.

FIG. 3B is a diagram illustrating a structure of an information recording medium 30 according to another example embodiment of the present invention. Referring to FIG. 3B, the information recording medium 40 includes a burst cutting area (BCA) 41, a lead-in area 42, a data area 43, and a lead-out area 44. EQ gain information 45 may be recorded in the BCA 41.

As illustrated in FIGS. 3A and 3B, EQ gain information is recorded in the lead-in area 31 or the BCA 41 but the present invention is not limited thereto. For example, the EQ gain information 35 or 45 may be recorded in a data area or a lead-out area. Thus, it is preferable, but not required, that the EQ gain information 35 or 45 be recorded in the lead-in area, the lead-out area, or the BCA. Also, the EQ gain information can be recorded more than once for reliable reading of the EQ information, though not required. Also, the EQ gain information can be recorded in two or more areas, for example, in the lead-in area and the BCA. In various example aspects, the EQ gain information can be recorded in a reserved area of the various areas.

If an information recording medium is a multi-layered medium comprising two or more recording layers, EQ gain information appropriate (or specific) for the respective layers may be recorded in each layer, a plurality of layers, or in a single layer. Also, if the information recording medium can be used at various write speeds, EQ gain information appropriate for the respective write speeds may be recorded. Also, if an information recording medium is recordable with different wavelength light, EQ gain information appropriate or specific for the different wavelength light may be recorded.

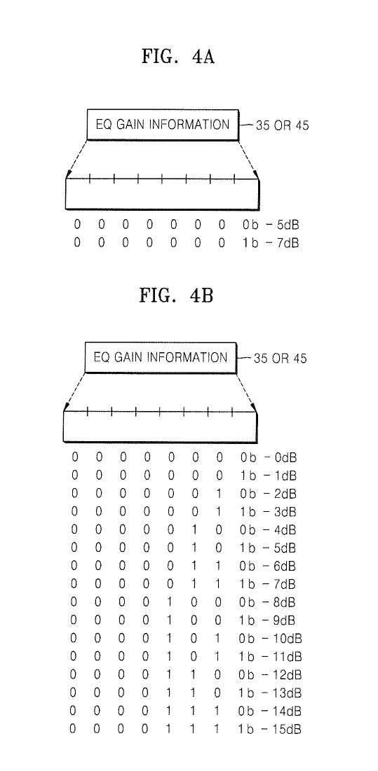

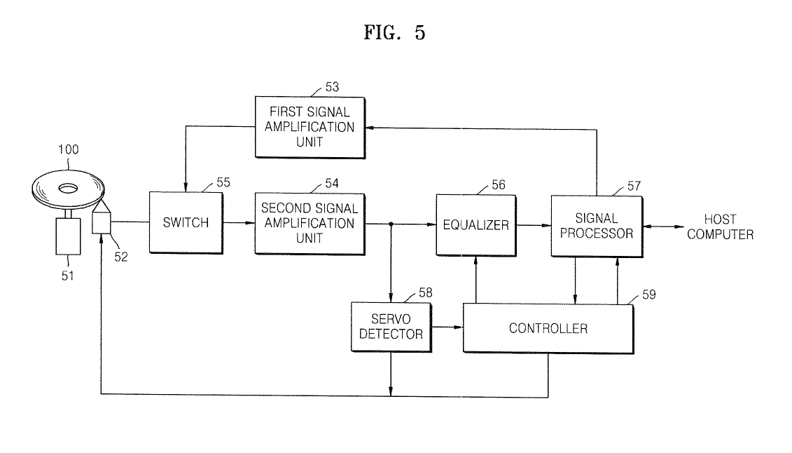

FIG. 4A illustrates a format of the EQ gain information 35 or 45 illustrated in FIG. 3A or FIG. 3B, according to an example embodiment of the present invention. Referring to FIG. 4A, if two different EQ values are allowed by an information recording medium, it is possible to express the two different EQ values by using one bit of the EQ gain information 35 or 45. For example, the least significant bit (LSB) of the EQ gain information is used. The EQ value may be 5 dB if the LSB is “0”, and 7 dB if the LSB is “1”, but is not limited thereto.

FIG. 4B illustrates a format of the EQ gain information 35 or 45 illustrated in FIG. 3A or FIG. 3B, according to another example embodiment of the present invention. Referring to FIG. 4B, for the EQ gain information 35 or 45, an EQ value may be expressed in the range from 0 dB to 15 dB. That is, if 4 bits of the EQ gain information 35 or 45 are used, “0000” represents that the EQ value is 0 dB and “1111” represents that the EQ value is 15 dB. Further, more than 4 bits may be used to express the EQ value. As shown in FIG. 4B, for example, 8 bits may be used. In other example embodiments, the EQ value need not be a binary number. FIGS. 4A and 4B illustrate examples of the format of the EQ gain information for expressing an EQ value. However, the format of the EQ gain information is not limited thereto, so long as it is appropriate or usable to express an EQ value appropriate for an information recording medium.

FIG. 5 is a schematic diagram of a recording/reproducing apparatus according to an example embodiment of the present invention. Referring to FIG. 5, the recording/reproducing apparatus includes a motor 51, a pickup 52, a first signal amplification unit 53, a second signal amplification unit 54, a switch 55, an equalizer 56, a signal processor 57, a servo detector 58, and a controller 59, for example.

The spindle motor 51 rotates an information recording medium 100. Although not shown, the pickup 52 includes a magnetic head that records a signal on or reproduces a signal from a signal recording surface of the information recording medium 100. The pickup 52 also includes an actuator (not shown) that moves the magnetic head in the diameter direction of the information recording medium 100.

The first signal amplification unit 53 amplifies the level of an information signal received from the signal processor 57 in order to record data on the information recording medium 100. The second signal amplification unit 54 amplifies the level of an information signal reproduced from the information recording medium 100. The switch 55 performs a switching operation between the first signal amplification unit 53 and the second signal amplification unit 54.

The equalizer 56 adjusts characteristics of the amplified signal received from the second signal amplification unit 54. The signal processor 57 performs decoding, e.g., error correcting coding (ECC), on the adjusted signal received from the equalizer 56. The servo detector 58 detects a servo signal from the signal received from the second signal amplification unit 54 and provides the servo signal to the controller 59. The controller 59 performs overall control on all the elements of the recording/reproducing apparatus.

In particular, according to an example embodiment of the present invention, the controller 59 controls the pickup 52 to read EQ gain information from a predetermined area of the information recording medium 100. Then, the pickup 52 reads the EQ gain information from the predetermined area of the information recording medium 100. The read EQ gain information is transmitted to the second signal amplification unit 54, the equalizer 56, the signal processor 57, and finally to the controller 59. The controller 59 sets a filter gain of a filter included in the equalizer 56 by using the received EQ gain information.

Accordingly, according to an example embodiment of the present invention, an optimal EQ value can be set by obtaining EQ gain information appropriate for an information recording medium directly from the information recording medium without using an EQ gain value set in a recording/reproducing apparatus, to thereby expedite setting of the optimal EQ value.

If the information recording medium 100 comprises a plurality of record layers and EQ gain information appropriate for each of the record layers is recorded therein, the controller 59 can read the EQ gain information from the information recording medium 100 and then set EQ values to be appropriate for the respective record layers in the equalizer 56.

If the information recording medium 100 can be used at various write speeds and EQ gain information appropriate for each of the speeds is recorded in the information recording medium 100, the controller 59 can read the EQ gain information from the information recording medium 100 and set EQ values to be appropriate for the respective speeds in the equalizer 56.

The recording/reproducing apparatus illustrated in FIG. 5 records data on or reproduces data from an already manufactured information recording medium, and a construction (or a layout) of the recording/reproducing apparatus illustrated in FIG. 5 is similar to that of a recording/reproducing apparatus that records EQ gain information on an information recording medium during manufacture of the information recording medium. Thus, an apparatus that obtains an EQ gain and records the EQ gain on an information recording medium during manufacture of the information recording medium will be described with reference to FIG. 5.

The controller 59 initializes a filter gain of the equalizer 56, and then detects a jitter value of a signal obtained by reproducing data from the information recording medium 100. Thereafter the controller 59 monitors the jitter value of the signal while adjusting the gain of the equalizer 56 so that the jitter value can be reduced. The controller 59 then determines the gain of the equalizer 56 when the jitter value is a minimum value. Next, the controller 59 controls the pickup 52 to record the determined EQ gain in a predetermined area of the information recording medium 100.

In this case, if the information recording medium 100 comprises a plurality of record layers, the controller 59 preferably determines EQ gains appropriate for the respective record layers and records them in the information recording medium 100. If the information recording medium can be used at various write speeds, it is preferable, but not required, that EQ gains appropriate for the respective speeds are determined and recorded in the information recording medium 100.

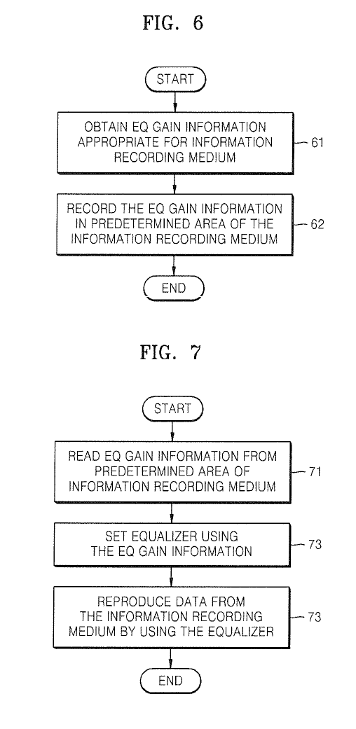

FIG. 6 is a flowchart illustrating a method of recording EQ gain information on an information recording medium, according to an example embodiment of the present invention. Referring to FIG. 6, EQ gain information appropriate for an information recording medium is obtained (operation 61). For example, a jitter value of a signal reproduced from the information recording medium is checked (detected or determined) while increasing a gain of an equalizer, (that is, a boost ratio). Accordingly, a boost ratio when the jitter value is at a minimum is detected while increasing or reducing the boost ratio so that the jitter value can be reduced. Thereafter the boost ratio of the minimum jitter value is determined as an EQ gain information appropriate for the information recording medium. If the information recording medium comprises a plurality of record layers, EQ gain information for the respective record layers is determined. If the information recording medium can be used at various write speeds, EQ gain information appropriate for the respective speeds is determined.

Next, the obtained EQ gain information is recorded in a predetermined area of the information recording medium (operation 62). If the information recording medium comprises a plurality of record layers, EQ gain information appropriate for the respective record layers is recorded. If the information recording medium can be used at various write speeds, EQ gain information appropriate for the respective speeds is recorded.

FIG. 7 is a flowchart illustrating a method of reproducing data from an information recording medium by obtaining EQ gain information from the information recording medium, according to an example embodiment of the present invention. Referring to FIG. 7, EQ gain information is read from a predetermined area of an information recording medium (operation 71). Next, an equalizer included in a reproducing apparatus is set using the EQ gain information (operation 72).

Then data is reproduced from the information recording medium by using the set equalizer (operation 73). Alternatively, it is possible to reproduce data from the information recording medium while increasing or reducing an EQ gain set in the equalizer in order to improve the quality of a signal reproduced from the information recording medium.

Example embodiments of the present invention can be embodied as computer readable code in a computer readable medium. Here, the computer readable medium may be any recording medium and/or apparatus capable of storing data that is read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable medium can be distributed among computer systems that are interconnected through a network, and the present invention may be stored and implemented as computer readable code in the distributed system. Programmers of ordinary skill in the technical field to which the present invention pertains could have easily derived a function program, code and code segments necessary for accomplishing the reproducing method according to the present invention.

As described above, according to the present invention, EQ values appropriate for an information recording medium are recorded in a predetermined area of the medium, and therefore, it is possible to rapidly set the EQ values for the medium when reproducing data from the medium.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the EQ gain information can be recorded in two or more areas, for example, in the lead-in area and the BCA. The EQ gain information can be recorded in a reserved area of the various areas. Also, if an information recording medium is recordable with different wavelength light, EQ gain information appropriate or specific for the different wavelength light may be recorded. EQ gain information may be expressed using up to 8 bits, for example. Accordingly, it is intended, therefore, that the present invention not be limited to the various example embodiments disclosed, but that the present invention includes all embodiments falling within the scope of the appended claims.

1. An information recording medium having a lead-in area, a lead-out area, and a data area, and containing data to be rendered via a recording/reproducing apparatus, the medium comprising equalizer (EQ) gain information recorded thereon, which is specific to the information recording medium, and which enables optimized reproduction of the data recorded on the information recording medium by the recording/reproducing apparatus.

2. The information recording medium of claim 1, wherein the equalizer gain information is recorded in at least one of the lead-in area, the lead-out area, and a burst cutting area (BCA) of the information recording medium.

3. The information recording medium of claim 1, wherein the equalizer gain information is a first equalizer gain or a second equalizer gain for reproduction of data from the information recording medium, where the first and second equalizer gains are expressed using one bit.

4. The information recording medium of claim 1, wherein the equalizer gain information is an equalizer gain for reproduction of data from the information recording medium, where the equalizer gain is expressed with a numerical value.

5. The information recording medium of claim 1, wherein the equalizer gain information is set to vary according to a record layer, a write speed, and/or material characteristics of the information recording medium.

6. An apparatus for reproducing data from and/or recording data on an information recording medium, the apparatus comprising:
a pickup unit to emit and/or receive a light to transfer data with respect to the information recording medium;
a controller to control the pickup unit to read equalizer (EQ) gain information that is recorded on the information recording medium, which is specific to the information recording medium, and which enables optimized reproduction of data from the information recording medium; and
an equalizer to equalize a signal output from the pickup unit according to the equalizer gain information.

7. The apparatus of claim 6, wherein the controller controls the pickup unit to read the equalizer gain information from at least one of a lead-in area, a lead-out area, and a burst cutting area (BCA) of the information recording medium.

8. The apparatus of claim 6, wherein the equalizer gain information is set to vary according to a record layer, a write speed, and/or material characteristics of the information recording medium.

9. A method of reproducing data from an information recording medium, the method comprising:
reading equalizer (EQ) gain information specific to the information recording medium, and which enables optimized reproduction of data from the information recording medium;
setting an equalizer according to the equalizer (EQ) gain information; and
equalizing a data signal read from the information recording medium using the set equalizer and then reproducing the data signal.

10. The method of claim 9, wherein the reading of the equalizer gain information comprises reading the equalizer gain information from at least one of a lead-in area, a lead-out area, and a burst cutting area (BCA) of the information recording medium.

11. The method of claim 9, wherein the equalizer gain information is set to vary according to a record layer, a write speed, and/or material characteristics of the information recording medium.

12. An apparatus for recording data on or reproducing data from an information recording medium, the apparatus comprising:
a recording/reading unit to record data on or read data from the information recording medium;
an equalizer to equalize a data signal read from the information recording medium via the recording/reading unit according to equalizer (EQ) gain information; and
a controller to determine the equalizer (EQ) gain information that is specific to the information recording medium, and which enables optimized reading of data from the information recording medium during equalizing of the read data signal by adjusting the equalizer gain (EQ), and to control the recording/reading unit to record or read the equalizer (EQ) gain information on the information recording medium.

13. The apparatus of claim 12, wherein the controller controls the recording/reading unit to record the EQ gain information in at least one of a lead-in area, a lead-out area, and a burst cutting area (BCA) of the information recording medium.

14. The apparatus of claim 12, wherein the controller determines that the equalizer gain information varies according to a record layer, a write speed, and/or material characteristics of the information recording medium.

15. A method of recording data on an information recording medium, the method comprising:
reading a data signal from the information recording medium;
determining equalizer (EQ) gain information specific to the information recording medium, and which enables optimized reading of the data signal from the information recording medium during equalizing of the read data signal by adjusting the equalizer (EQ) gain; and
recording the equalizer (EQ) gain information on the information recording medium.

16. The method of claim 15, wherein the recording of the equalizer gain information comprises recording the equalizer gain information in at least one of a lead-in area, a lead-out area, and a burst cutting area (BCA) of the information recording medium.

17. The method of claim 15, wherein the determining of the equalizer gain information comprises determining that the equalizer gain information varies according to a record layer, a write speed, and/or material characteristics of the information recording medium.

18. The information recording medium of claim 1, wherein the equalizer gain information is a value having a minimum jitter value.

19. The information recording medium of claim 1, wherein the equalizer gain information is specific as to whether the information recording medium is a write-once disc or a rewritable disc.

20. The apparatus of claim 6, wherein the equalizer information is a value having a minimum Jitter value.
